(19) United States
(12) Patent Application Publication
(10) Pub. No.: US 2011/0142523 A1
(43) Pub. Date: Jun. 16, 2011

(54) KEY TOP MEMBER FOR PUSH BOTTOM SWITHC STRUCTURE

(75) Inventors: GUO-JUN BAI, Shenzhen (CN); YAN-DONG ZHU, Shenzhen (CN); YU-LUNG HO, Tu-Cheng (TW)

(73) Assignee: HON HAI PRECISION INDUSTRY CO., LTD., Tu-Cheng (TW)

(21) Appl. No.: 12/959,379

(22) Filed: Dec. 3, 2010

(30) Foreign Application Priority Data
Dec. 10, 2009 (CN) 200910311152.2

(51) Int. Cl. B41J 5/12; H01H 11/00

(52) U.S. Cl. 400/493; 29/622

(57) ABSTRACT

A key top member used in an input device includes a base sheet, a lower colored layer coated on the base sheet and coated with a transparent protecting layer thereon, an upper layer coated on the protecting layer, and a top layer coated on the upper layer. The top layer and the upper colored layer are pierced with open indicating an displaying symbol.

### BACKGROUND OF THE INVENTION

1. Field of the Invention

The present invention generally relates to a key top member for a push button switch structure suitable for usage in mobile communication equipment such as a mobile phone or a car phone, a home telephone, an electronic notebook, a measuring instrument, a vehicle mounted-switch, a remote control, a computer, a personal computer, or the like (collectively, named as input device), more particularly to a key top member for a push button switch structure which permits a display section such as a symbol, a letter, a pattern or the like printed on a sheet to exhibit enhanced design characteristics and durability and is used for a back-lighted push button switch structure as well.

2. Description of the Prior Art

In general, a push button switch structure is so constructed that a key top member or a cover having key top elements arranged thereon is mounted on a circuit board received in a casing of the equipment, to thereby function as a switch structure for carrying an ON-OFF operation of a circuit of the equipment. Such a push button switch structure typically has a key top member incorporated therein, which is formed of thermoplastic resin into a predetermined configuration by injection molding. Recently, it has been demanded to apply a variety of designs such as a symbol, a pattern and the like to the key top by printing. The symbol or/and pattern can be formed on the key top member by laser's irradiation. After completion of irradiation, the key top member with irradiated symbols and patterns are then assembled in the casing of mobile phone. The symbols and the patterns on the key top members of the mobile phones are specified in response to languages and custom of a predetermined country the mobile phone will sell in.

It will be happened that mobile phones originally planed to launch in one country might overstock in said one country. The key top member can no longer used. So, a key top member without any symbol and pattern after it is assembled to the casing of the mobile phone, is desired.

### BRIEF SUMMARY OF THE INVENTION

Therefore, an object of the present invention is to provide a key top member without any symbols and patterns after assembled in an input device, such as mobile phones.

To fulfill the above-mentioned object, a key top member used in an input device comprises a base sheet, a lower colored layer coated on the base sheet and coated with a transparent protecting layer thereon, an upper layer coated on the protecting layer, and a top layer coated on the upper layer. The top layer and the upper colored layer are pierced with opens indicating a displaying symbol.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a top perspective view of a key top member made in accordance with the present invention;

FIG. 2 is a schematic cross sectional view of the key top member without any symbols and patterns thereon;

FIG. 3 is a schematic cross sectional view of the key top member, wherein symbols and patterns are formed by laser's irradiation;

FIG. 4 is a top plan view of a mobile phone in which the key top member without any symbols and patterns is assembled; and

FIG. 5 is a top plan view of the mobile phone of FIG. 4 which is irradiated with symbols and patters.

### DETAILED DESCRIPTION OF THE PREFERRED EMBODIMENT

Reference will now be made in detail to the preferred embodiment of the present invention.

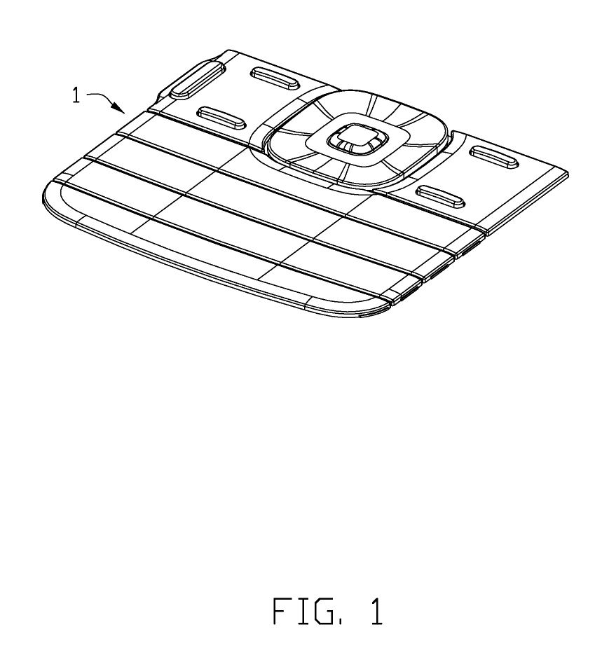

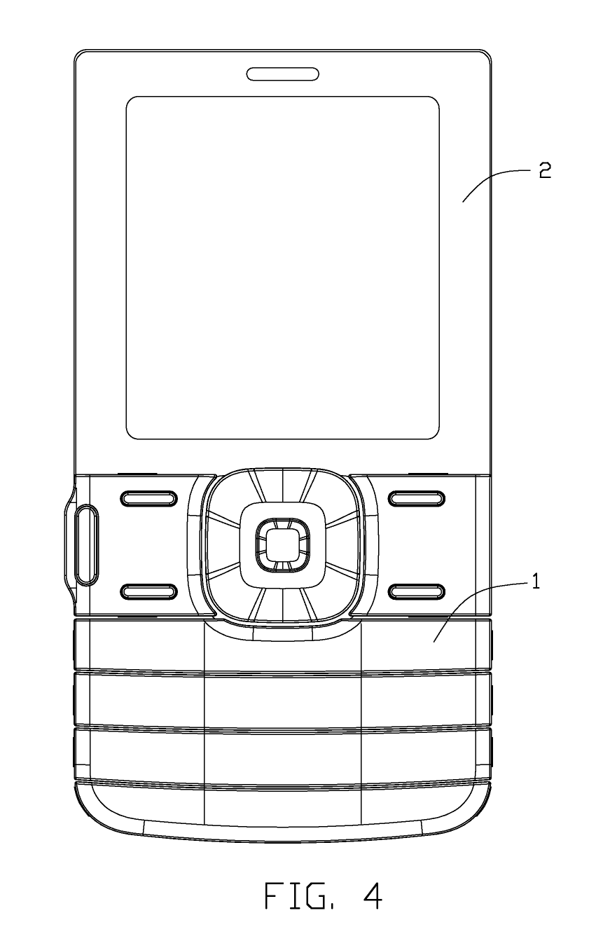

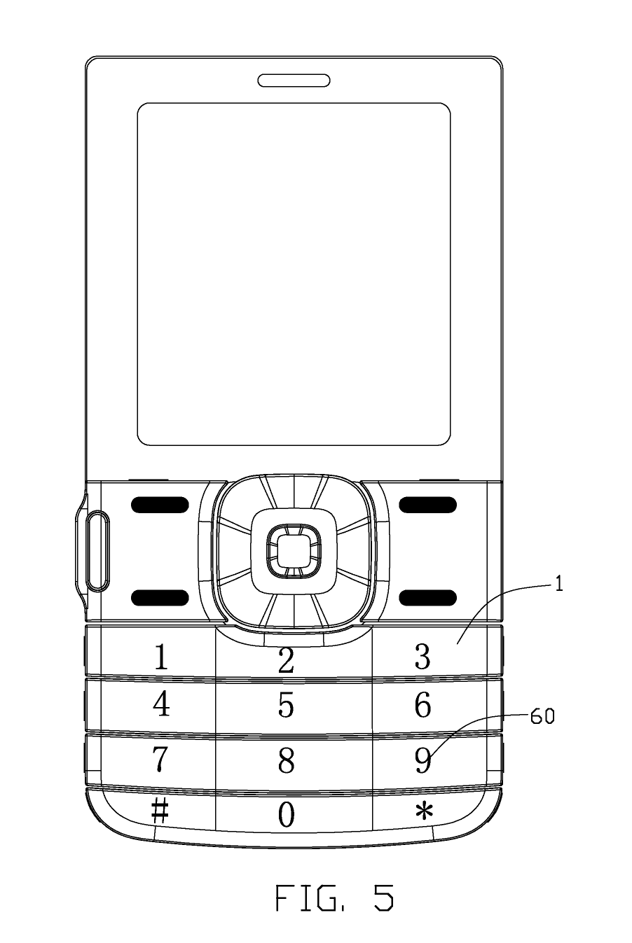

With reference to FIGS. 1, 4 and 5, an embodiment of a key top member 1 for a push button switch structure according to the present invention is illustrated to be used at a mobile phone 2. The key top member 1 of the illustrated embodiment is completed without any symbols and pattern or the like as shown in FIG. 1. The blank key top member 1 is assembled to the mobile phone 2 as shown in FIG. 4 and then the key top member 1 is deposited with symbols and pattern or the like such as numerals 1˜9 and symbols #, * and so on, as shown in FIG. 5, collectively, named as displaying symbols.

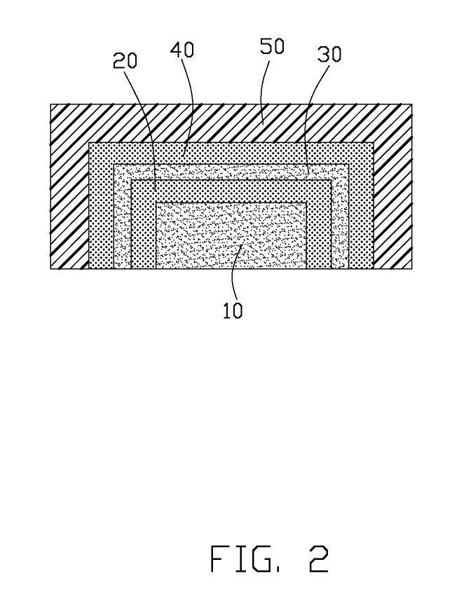

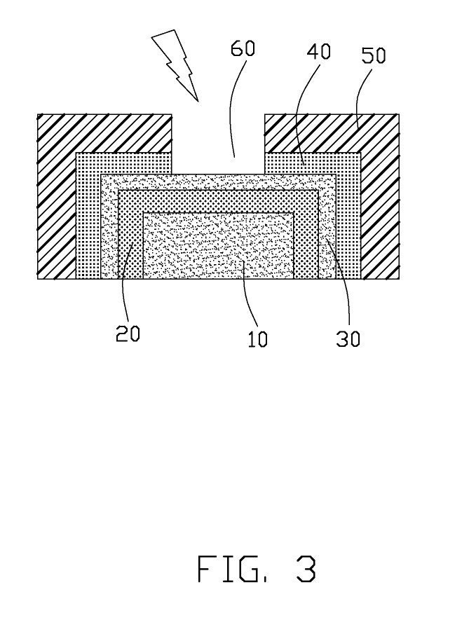

FIGS. 2 and 3 shows a laminate of the key top member 1. The key top member 1 includes a base sheet 10, a lower colored layer 20, a protecting layer 30, an upper colored layer 40 and a top layer 50. Said each former layer is superimposed above each latter layer in turn, to constitute the key top member 1. The base sheet 10 is the lowest layer confronting with a circuit board (not shown), which generally is made from soft and elastic material such as thermoplastic resin and silicone rubber. The base sheet 10 can be transparent or semitransparent. As shown in FIG. 1, a key unit is constituted of specified arrayed keys.

The lower colored layer 20 is coated on a top surface of the base sheet 10. The lower colored layer 20 is formed by spraying colored paint or printing colored ink on the base sheet 10. The color for the lower colored layer 20 is selected by manufacturer according to overall design of the mobile phone 2.

The protecting layer 30 is coated on a top surface of the lower colored layer 20, which is formed by transparent painting. The lower colored layer 20 displays through the protecting layer 30 at the top surface of the lower colored layer 20.

The upper colored layer 40 is coated on a top surface of the protecting layer 30. The upper colored layer 40 also is formed by spraying colored paint or printing colored ink. The upper and lower colored layers 20, 40 are be colored paint or colored ink.

The top layer 50 made form UV (ultraviolet-cured resin), is coated on a top face of the upper colored layer 40. After irradiation of ultraviolet beans, the upper colored layer 50 is harden to attach on the upper colored layer 40. The top layer 50 is different from the lower colored layer 20 in color.

The completed laminate of the key top member 1 without any symbols and patterns or the like is assembled together as a key unit as shown in FIG. 1 and then the key unit is assembled in the mobile phone 2. Please notes, the base sheets 10 of the array of the key can be discrete and separate from each other, or make from a single piece of silicon rubber. After determination of which country the mobile phone 2 will be sold, the key top member 1 is deposited with displaying symbols. As shown in FIG. 3, a laser bean is irradiated on the top layer 60, thereby etching and piercing the top layer 50 and the upper colored layer 40 to form three-dimensional opens 60 and expose the color of the lower colored layer 20 through these opens and the transparent protecting layer 30. Each open 60 indicates one designed display symbols. The transparent protecting layer 30 is used to prevent the lower colored layer 20 from etching by the laser beans and missing colors. The different color between the top layer 50 and the lower colored layer 20 benefit user observe displaying symbols, even in a circumstance without any back-light.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. A key top member used in an input device, comprising:
a base sheet;
a lower colored layer coated on the base sheet and coated with a transparent protecting layer thereon;
an upper colored layer coated on the protecting layer;
a top layer coated on the upper colored layer;
the top layer and the upper colored layer being pierced with opens indicating an displaying symbol.

2. The key top member as claimed in claim 1, wherein the key top member is irradiated by laser beans after the key top member is assembled in the input device.

3. The key top member as claimed in claim 2, wherein the lower colored layer is formed by spraying colored paint or printing colored ink on the base sheet.

4. The key top member as claimed in claim 3, wherein the protecting layer is formed on the lower colored layer by spraying transparent paint.

5. The key top member as claimed in claim 4, wherein the upper colored layer colored layer is formed by spraying colored paint or printing colored ink.

6. The key top member as claimed in claim 5, wherein the top layer is formed from ultraviolet-cured resin material.

7. The key top member as claimed in claim 1, wherein the upper colored layer colored layer is different from the lower colored layer in color.

8. A key top member for use with an input device, comprising:
a base sheet;
a lower colored layer coated upon the base sheet;
an upper colored layer directly applied upon the lower colored layer if the lower colored layer is capable of resisting later laser edging, or indirectly via a transparent protecting layer if the lower colored layer is not;
a top layer coated upon the upper colored layer;
the top layer and the upper colored layer being pierced with openings via said laser edging procedure to expose the lower colored layer for symbol indication.

9. A method of making an input device, comprising steps of:
providing a key top member assembly including a base sheet, a lower colored layer, an upper colored layer and a top layer applied with one another in sequence under condition that a transparent protecting layer is optionally sandwiched between the lower colored layer and the upper colored layer if the lower colored layer is not capable of resisting laser edging;
assembled said key top member assembly to an opening of a panel of said input device as a sub-assembly for delivery; and
forming a symbol on the key top member via a laser edging procedure to remove aligned portions of the top layer and the upper colored layer for exposing a specific configuration of the lower colored layer according to culture differences after said delivery.
